(19) United States
(12) Patent Application Publication
(10) Pub. No.: US 2014/0112832 A1
(43) Pub. Date: Apr. 24, 2014

(54) THREADED NOZZLE AND CLOSABLE NOZZLE VALVE ASSEMBLY

(71) Applicant: REC SILICON INC, Moses Lake, WA (US)

(72) Inventor: Billy Gene Lacy, Moses Lake, WA (US)

(73) Assignee: REC SILICON INC, Moses Lake, WA (US)

(21) Appl. No.: 13/656,606

(22) Filed: Oct. 19, 2012

(51) Int. Cl. B01J 8/18; B01J 19/00; B23P 6/00

(52) U.S. Cl. 422/139; 29/402.08; 422/310

(57) ABSTRACT

Embodiments of a nozzle assembly and a closable valve assembly for use in a fluid bed reactor system are disclosed. The nozzle assembly includes a first member that extends upwardly through a bottom wall of a fluid bed reaction chamber, and a second member. The first and second members are detachably fitted together via threads on each member. The second member can be removed and/or replaced, thereby facilitating fluid bed reactor maintenance. The closable valve assembly is connected to a nozzle, and includes a valve body and a gate pivotally connected to the valve body. The gate is movable between a first position at least partially covering the nozzle orifice in the absence of gas flow through the orifice, and a second position wherein the orifice is not covered when gas flows through the orifice.

### FIELD

The present disclosure relates a nozzle assembly for use with a fluid bed reactor, such as a fluid bed reactor for pyrolytic decomposition of a silicon-bearing gas to produce silicon-coated particles.

### BACKGROUND

Pyrolytic decomposition of silicon-bearing gas in fluidized beds is an attractive process for producing polysilicon for the photovoltaic and semiconductor industries due to excellent mass and heat transfer, increased surface for deposition, and continuous production. Compared with a Siemens-type reactor, the fluidized bed reactor offers considerably higher production rates at a fraction of the energy consumption. The fluidized bed reactor can be continuous and highly automated to significantly decrease labor costs.

Gases, including a silicon-bearing gas, flow into the fluidized bed reactor through nozzles. Silicon is deposited on particles in the reactor by decomposition of the silicon-bearing gas. Control over the gas flow (e.g., volume, velocity) is important to maintain desired conditions within the fluidized bed reactor. Gas flow can affect, for example, the extent of fluidization, rate of silicon deposition, particle size and/or uniformity, temperature in a given area of the reactor, fouling of components, and combinations thereof.

A common problem in fluidized bed reactors is fouling of interior components and surrounding reactor walls as silicon deposits form on surfaces during pyrolysis. Another common problem is clogging of nozzles that can occur when gas flow decreases or ceases, and seed and/or product particles fall into upwardly oriented nozzles. To avoid or minimize these problems with conventional nozzles, a gas (e.g., a non-silicon-containing gas) may be flowed through the nozzle(s) at a sufficient velocity to prevent particles from falling into the nozzle(s). However, when nozzles become fouled or occluded, they may need to be removed and replaced.

### SUMMARY

Embodiments of a nozzle assembly and a closable valve assembly for use in a fluid bed reactor system are disclosed. Embodiments of the nozzle assembly include a first member configured to extend upwardly from a bottom wall of a fluid bed reaction chamber, and a second member. The first member includes an inlet at a first end positioned at or below the bottom wall of the fluid bed reaction chamber and an upwardly facing outlet at a distal end that is positioned above the inlet when the nozzle is installed in a fluid bed reactor. The first member defines a passageway in fluid communication with the inlet and the outlet. In some embodiments, the inlet also is in fluid communication with a gas source, such as a silicon-bearing gas. The first member further includes threads adjacent to the outlet. The second member includes an inlet at a first end and an upwardly facing orifice at a second end. The second member defines a passageway in fluid communication with the inlet and the outlet. The second member inlet is in fluid communication with the first member outlet. The second member further includes threads adjacent to the inlet. The second member threads are positioned and cooperatively dimensioned to engage with the first member threads on such that the first member and the second member are detachably fitted together. In some embodiments, the first member and/or the second member is rectilinear.

The nozzle assembly may further include an orifice plate positioned within at least one of the passageways to restrict a flow of gas through the passageways, the orifice plate being removable when the first member and the second member are not fitted together.

In one arrangement, the first member threads are on an outer wall surface adjacent to the first member outlet, and the second member threads are on an inner wall surface adjacent to the second member inlet. In another arrangement, the first member threads are on an inner wall surface adjacent to the first member outlet, and the second member threads are on an outer wall surface adjacent to the second member inlet.

In some embodiments, an insulating member is positioned around the first member, the second member, or both the first member and the second member.

In some embodiments, the nozzle assembly further includes a tubular outer member positioned around the first member, the second member, or both. The outer member has a wall spaced apart from an outer surface of the first member, the second member, or both the first member and the second member, thereby defining an annular space between the outer member wall and the outer surface. The annular space may be in fluid communication with a gas source. In certain embodiments, an insulating member is positioned around the outer member. Thus, the nozzle assembly may include an outer member positioned concentrically around the first member and/or second member, and an insulating member positioned concentrically around the outer member.

Embodiments of a closable nozzle assembly for a heated silicon deposition reactor include a nozzle configured to extend upwardly into a reaction chamber of a heated silicon deposition reactor system, and a valve assembly connected to the nozzle. The nozzle has an inlet in fluid communication with a gas source and an upwardly facing orifice in fluid communication with the inlet and positioned to inject a gas upwardly into the reaction chamber. The valve assembly includes a valve body and a gate pivotally connected to the valve body, wherein the gate is movable between a first position wherein the orifice is at least partially covered in the absence of gas flow, and a second position wherein the orifice is not covered when gas flows through the orifice. An insulating member may be positioned around the nozzle.

In some embodiments, the nozzle is a threaded nozzle assembly as disclosed herein. In such embodiments, the valve assembly may be connected to the second member. In one embodiment, the closable nozzle assembly further includes an insulating member positioned around the first member, the second member, or both the first member and the second member. In another embodiment, the closable nozzle assembly further includes a tubular outer member positioned around the first member, the second member, or both the first member and the second member, wherein the outer member comprises a wall spaced apart from an outer surface of the first member, the second member, or both the first member and the second member, thereby defining an annular space between the outer member wall and the outer surface, wherein the annular space is in fluid communication with a gas source. An insulating member may be positioned around the outer member.

In some embodiments, the valve assembly is removably connected to the nozzle. In one embodiment, the nozzle includes threads on an inner wall surface adjacent to the orifice and the valve assembly includes threads on an outer wall surface of a lower portion of the valve body. In another embodiment, the nozzle includes threads on an outer wall surface adjacent to the orifice and the valve assembly includes threads on an inner wall surface of a lower portion of the valve body. The valve assembly threads are positioned and cooperatively dimensioned to engage with the nozzle threads such that the valve assembly and the nozzle are detachably fitted together.

Embodiments of a fluid bed reactor may include an outer wall surrounding a reaction chamber, a nozzle assembly as disclosed herein, and a gas source in fluid communication with the first member inlet. The fluid bed reactor further may include an embodiment of a closable valve assembly as disclosed herein.

Embodiments of the disclosed nozzle assembly facilitate maintenance of a fluid bed reactor. With the reactor in a non-fluidized state, the second member of the nozzle is detached from the first member by disengaging the second member threads from the first member threads, and removed from the reaction chamber. A replacement second member is then inserted into the reaction chamber. The replacement second member includes an inlet at a first end in fluid communication with an upwardly facing orifice at a second end, and threads adjacent to the inlet that are positioned and cooperatively dimensioned to engage with the threads on the first member. The replacement second member threads are engaged with the first member threads to provide a nozzle assembly. The replacement second member may have a different length, a different diameter or configuration (e.g., an outward flare or inward taper at its upper end), and/or be constructed of different material(s) than the original second member.

The foregoing and other objects, features, and advantages of the invention will become more apparent from the following detailed description, which proceeds with reference to the accompanying figures.

### BRIEF DESCRIPTION OF THE DRAWINGS

FIG. 1 is a schematic view of a fluid bed reactor comprising one exemplary embodiment of a threaded nozzle assembly.

FIG. 2 is a schematic view of the threaded nozzle assembly of FIG. 1.

FIG. 3 is a schematic view of an exemplary orifice plate for use with the threaded nozzle assembly of FIG. 1.

FIG. 4 is a vertical cross-sectional view of a portion of a threaded nozzle assembly including the orifice plate of FIG. 3.

FIG. 5 is a schematic view of an exemplary first member and second member of the threaded nozzle assembly of FIG. 1.

FIG. 6 is a schematic view of another exemplary first member and second member of the threaded nozzle assembly of FIG. 1.

FIG. 7 is a vertical cross-sectional view of another exemplary embodiment of a threaded nozzle assembly.

FIG. 8 is a vertical cross-sectional view of an exemplary embodiment of an insulated nozzle assembly.

FIG. 9 is a vertical cross-sectional view of another exemplary embodiment of an insulated nozzle assembly.

FIG. 10 is a vertical cross-sectional view of an exemplary embodiment of a closable valve in the closed position.

FIG. 11 is a vertical cross-sectional view of the closable valve of FIG. 10 in the open position.

FIG. 12 is a vertical cross-sectional view of the closable valve of FIGS. 10 and 11 on a nozzle.

FIG. 13 is a schematic view a fluid bed reactor comprising one exemplary embodiment of a threaded nozzle assembly and one exemplary embodiment of a closable valve in the open position.

### DETAILED DESCRIPTION

Disclosed herein are embodiments of a threaded nozzle assembly and a closable valve assembly for use in a fluid bed reactor system, such as a fluid bed reactor system for the formation of polysilicon by pyrolytic decomposition of a silicon-bearing gas and deposition of silicon onto fluidized silicon particles or other seed particles (e.g., silica, graphite, or quartz particles).

The manufacture of particulate polycrystalline silicon by a chemical vapor deposition method involving pyrolysis of a silicon-containing substance such as for example silane, disilane or halosilanes such as trichlorosilane or tetrachlorosilane in a fluidized bed reactor is well known to a person skilled in the art and exemplified by many publications including the following patents and publications: U.S. Pat. No. 8,075,692, U.S. Pat. No. 7,029,632, U.S. Pat. No. 5,810,934, U.S. Pat. No. 5,798,137, U.S. Pat. No. 5,139,762, U.S. Pat. No. 5,077,028, U.S. Pat. No. 4,883,687, U.S. Pat. No. 4,868,013, U.S. Pat. No. 4,820,587, U.S. Pat. No. 4,416,913, U.S. Pat. No. 4,314,525, U.S. Pat. No. 3,012,862, U.S. Pat. No. 3,012,861, US2010/0215562, US2010/0068116, US2010/0047136, US2010/0044342, US2009/0324479, US2008/0299291, US2009/0004090, US2008/0241046, US2008/0056979, US2008/0220166, US 2008/0159942, US2002/0102850, US2002/0086530, and US2002/0081250.

Silicon is deposited on particles in a reactor by decomposition of a silicon-bearing gas selected from the group consisting of silane (SiH₄), disilane (Si₂H₆), higher order silanes (SiₙH₂ₙ₊₂), dichlorosilane (SiH₂Cl₂), trichlorosilane (SiHCl₃), silicon tetrachloride (SiCl₄), dibromosilane (SiH₂Br₂), tribromosilane (SiHBr₃), silicon tetrabromide (SiBr₄), diiodosilane (SiH₂I₂), triiodosilane (SiHI₃), silicon tetraiodide (SiI₄), and mixtures thereof. The silicon-bearing gas may be mixed with one or more halogen-containing gases, defined as any of the group consisting of chlorine (Cl₂), hydrogen chloride (HCl), bromine (Br₂), hydrogen bromide (HBr), iodine (I₂), hydrogen iodide (HI), and mixtures thereof. The silicon-bearing gas may also be mixed with one or more other gases, including hydrogen (H₂) or one or more inert gases selected from nitrogen (N₂), helium (He), argon (Ar), and neon (Ne). In particular embodiments, the silicon-bearing gas is silane, and the silane is mixed with hydrogen.

The silicon-bearing gas, along with any accompanying hydrogen, halogen-containing gases and/or inert gases, is introduced via one or more nozzles into a fluidized bed reactor and thermally decomposed within the reactor to produce silicon which deposits upon seed particles inside the reactor. Nozzle fouling may occur as silicon deposits form on exterior and interior surfaces of the nozzles. Interior fouling may occur when a portion of the silicon-bearing gas decomposes and deposits silicon on an interior surface of the nozzle.

Interior nozzle fouling and/or clogging also may occur if seed and/or product particles fall into the nozzle. Occlusion is a particular problem when the fluid bed reactor is initially being charged with seed particles prior to reactor operation. Occlusion also can occur if gas flow to one or more nozzle(s) ceases while an upper boundary of the fluidized (or non-fluidized) bed is above the nozzle opening(s).

Fouling and/or clogging produce a variable inner diameter within the nozzle and/or affect gas flow velocity through the nozzle. When a nozzle become sufficiently fouled or clogged, fluid bed reactor operation is halted for maintenance. In some instances, it may be possible to drill through the debris clogging the nozzle and re-establish sufficient gas flow. However, some variability in nozzle diameter and flow characteristics may remain, thereby affecting flow velocity and/or gas plume geometry.

When the nozzle performance is sufficiently comprised, the nozzle is removed and replaced. Because injection and fluidization nozzles typically extend through a fluid bed reactor's lower wall, or bottom head, nozzle replacement is not a trivial matter. Reactor operation must be halted, and typically the reactor must be substantially emptied of seed and/or product particles. Fittings and/or seals may become worn or damaged as nozzles are removed and replaced, leading to reactive gas leaks and potential fires.

### I. Nozzle Assembly

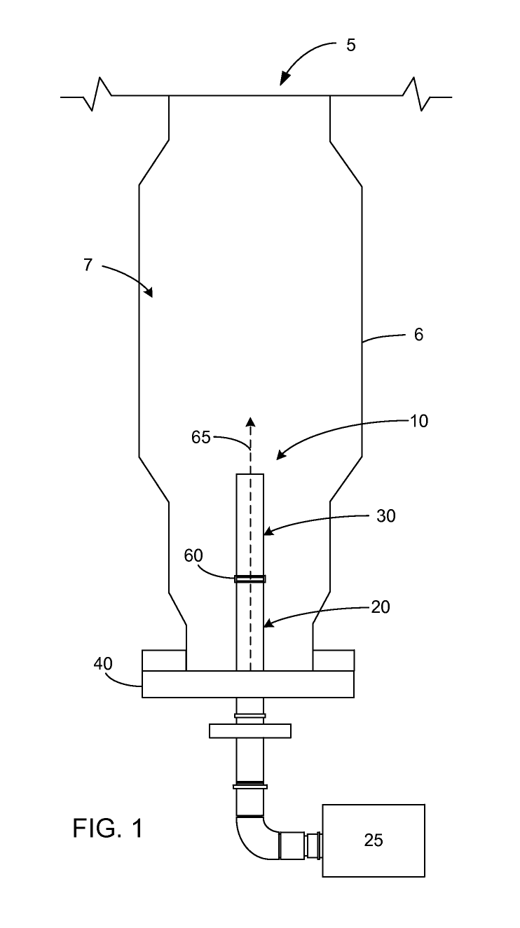

FIG. 1 is a simplified schematic diagram of a fluid bed reactor 5 including an exemplary embodiment of a threaded nozzle assembly 10. An outer wall 6 defines a reaction chamber 7.

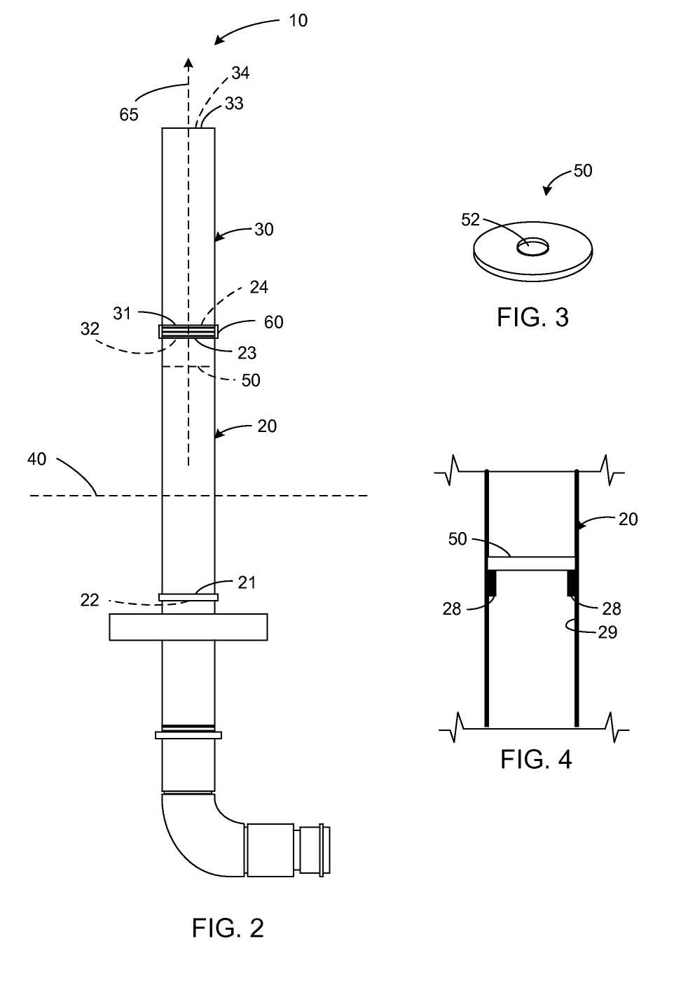

FIG. 2 is a schematic diagram of the threaded nozzle assembly 10 illustrated in FIG. 1. Nozzle assembly 10 comprises a first member 20 and a second member 30. Each member 20, 30 may consist of one or more parts. The illustrated first member 20 includes a substantially tubular section configured to extend through a bottom wall, or bottom head, 40 of fluid bed reactor 5. In some embodiments, first member 20 has a rectilinear configuration, and extends vertically upwardly from the bottom wall 40. First member 20 has a first end 21, positioned at or below bottom wall 40, and a second or distal end 23 located above the first end 21. The illustrated first member is a pipe defining a passageway for delivering gas into reaction chamber 7. A gas inlet 22 is located at the first end 21, and an upwardly facing outlet 24 is located at the second end 23. Inlet 22 is in fluid communication with outlet 24. Inlet 22 also is in fluid communication with a gas source 25, e.g., a source of a reaction gas.

The illustrated second member 30 includes a substantially tubular section comprising a first end 31 comprising an inlet 32 and a second end 33 comprising an orifice, or outlet, 34. The illustrated second member is a pipe defining a passageway for delivering gas into reaction chamber 7. In the illustrated embodiment of FIGS. 1 and 2, second member 30 is rectilinear and has a single, upwardly facing orifice 34. First member 20 and second member 30 are detachably coupled via a threaded portion 60. The passageway defined by first member 20 is in fluid communication with second member 30 so that a gas 65 (e.g., a reaction gas such as a silicon-bearing gas) can flow upwardly through first and second members 20, 30. Second member 30 may have the same inner diameter or a different inner diameter than first member 20.

In some embodiments, first member 20 further includes an orifice plate 50 positioned within the passageway defined by the pipe. FIG. 3 illustrates an exemplary embodiment of an orifice plate 50 having an aperture 52 therethrough. Typically, the aperture is centrally located in plate 50. First member 20 may include an inwardly facing support 28 having an upwardly facing surface on which orifice plate 50 is supported (FIG. 4). In one example, support 28 is an annular ridge or lip. In another example, support 28 is a plurality of inwardly facing supports spaced around an inner surface 29. When present, orifice plate 50 restricts gas flow as a function of the size of aperture 52, producing increased back-pressure of gas 65 below the orifice plate, and a lower gas pressure above the plate. Orifice plate 50 facilitates flow consistency (e.g., velocity, pressure) within second member 30.

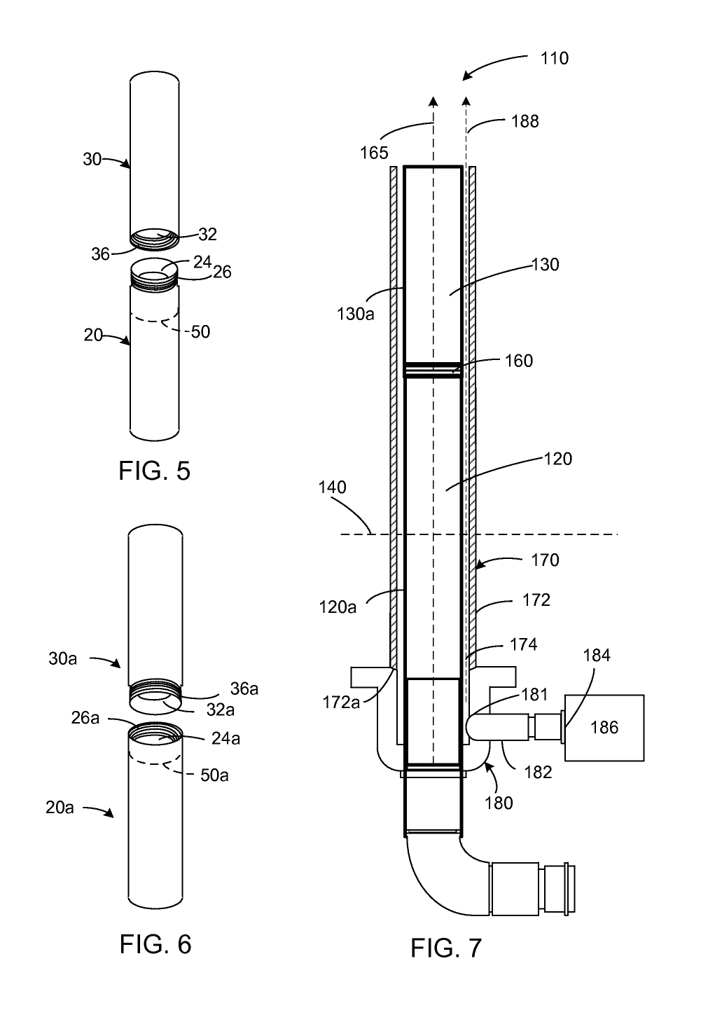

In some embodiments, first member 20 includes external threads 26 on an outer wall adjacent to outlet 24 (FIG. 5). Second member 30 includes internal threads 36 on an inner wall adjacent to inlet 32. Threads 36 are cooperatively dimensioned to engage with threads 26 such that first member 20 and second member 30 can be detachably fitted together. When coupled, the facing internal and external threads together form threaded portion 60 (FIGS. 1, 2). An orifice plate 50 may be positioned within first member 20.

In another arrangement (not shown), an orifice plate 50 could rest on and be supported by the upper end 23 of the first member 20. When the first and second members are engaged, an upper edge of threads 36 may exert a downward pressure on orifice plate 50, thereby firmly seating the orifice plate. Alternatively, the second member may include an inwardly facing support having a downwardly facing surface adjacent an upper edge of threads 36, which may exert downward pressure on the orifice plate when the first and second members are coupled.

In another arrangement (FIG. 6), first member 20a includes internal threads 26a on an inner wall adjacent to outlet 24a, and second member 30a includes external threads 36a on an outer wall adjacent to inlet 32a. Again, threads 26a and threads 36a are cooperatively dimensioned so that first and second members 20a, 30a can be detachably fitted together. An orifice plate 50a may be positioned within first member 20a. In some embodiments, support 28a (not shown) is positioned adjacent to a lower edge of threads 26a, and orifice plate 50a is positioned such that when second member 30a is coupled to first member 20a, a lower edge of threads 36a applies pressure to a top surface of orifice plate 50a, thereby firmly seating orifice plate 50a within first member 20a.

Components of the disclosed nozzle assemblies, including first member 20, second member 30, and orifice plate 50 are constructed using any material that is acceptable within the expected pressure, temperature and stress requirements within the fluidized bed reactor. Suitable materials for use in a heated silicon deposition reactor include high-temperature metal alloys such as, but not limited to, INCOLOY® and HASTALLOY™ alloys. First member 20, second member 30, and orifice plate 50 may be constructed of the same materials, or different materials. In some embodiments, first member 20 and second member 30 are constructed of different materials to reduce galling. Surfaces exposed to seed particles, product particles, and/or reaction gases may be coated, e.g., with silicon carbide, for product quality.

Embodiments of the disclosed threaded nozzle assemblies provide advantages over conventional nozzles. For example, second member 30 may be uncoupled from first member 20, allowing replacement of second member 30. Replacement of the entire nozzle assembly 10 is avoided. Additionally, second member 30 can be removed from inside the reaction chamber 7, and can be replaced without cutting, welding, or risk of reactive gas leaks. Embodiments of the disclosed threaded nozzle assemblies and are suitable for use with a welded gas ring header, thereby reducing fire risk when reactive gases are utilized within the reactor. If the upper surface of the particle bed in the reactor is below threaded portion 60 when the reactor is at rest (i.e., in a non-fluidized state), second member 30 can be replaced without emptying the reactor of seed and/or product particles. Orifice plate 50 also may be removed and replaced when second member 30 is uncoupled from first member 20. Threaded nozzle assembly 10 also provides versatility. As desired, second member 30 can be replaced with a subsequent second member that has a different length, a different diameter or configuration (e.g., an outward flare or inward taper at its upper end), and/or is constructed of different material(s).

FIG. 7 is a schematic diagram of another exemplary embodiment of a threaded nozzle assembly 110. Nozzle assembly 110 includes a first substantially tubular member 120 and a second substantially tubular member 130. First member 120 extends through a bottom wall 140 of a fluid bed reactor. First member 120 and second member 130 are detachably coupled via a threaded portion 160. First member 120 is in fluid communication with second member 130 such that a gas 165 can flow upwardly through first and second members 120, 130. Nozzle assembly 110 further includes a substantially tubular outer member 170 surrounding first member 120, second member 130, or both as illustrated. As illustrated, outer member 170 comprises a wall 172 spaced concentrically apart from an outer wall surface 120a of first member 120, an outer wall surface 130a of second member 130, or both, to provide an annular space 174. Flange unit 180 comprises an inlet 181 in fluid communication with annular space 174. A nipple 182 has a passageway in fluid communication with the inlet 181, and has an inlet 184 adapted for connection to a gas source 186. A gas 188 (for example, a secondary or fluidizing gas) can flow into annular space 174 through inlet 181, and upwardly through annular space 174. Outer member 170 surrounds first and/or second members 120, 130. In some embodiments, a lower portion 172a of wall 172 tapers downwardly to form a gas-tight fit against flange unit 180.

As desired, second member 130 can be uncoupled from first member 120 and replaced without having to remove or replace outer member 170, and without having to remove nozzle assembly 110 from the reactor. Outer member 170 can be removed by disrupting the gas-tight seal formed by lower wall portion 172a, and then removing outer member 170. As desired, a replacement outer member can be fitted over the nozzle and sealed at a lower edge by any suitable means.

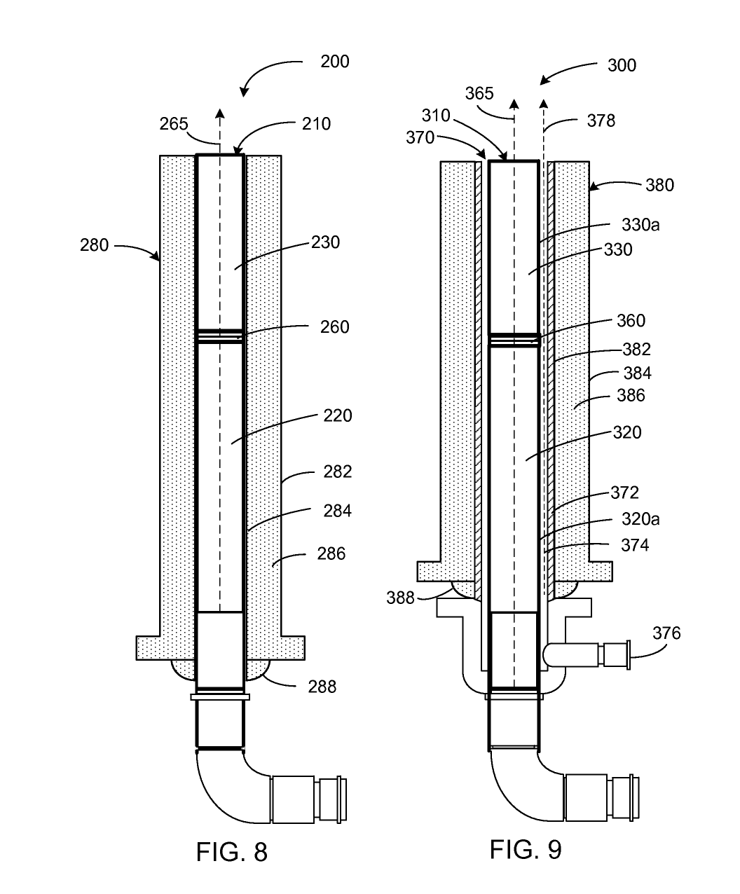

In some fluid bed reactors, the temperature within one or more nozzles may exceed a desirable operating temperature for the fluidized bed. For example, in a polysilicon fluid bed reactor, the temperature in a fluidization nozzle may reach temperatures greater than 600° C. Accordingly, it may be advantageous to insulate the nozzle to avoid overheating the fluidized bed. FIG. 8 is a schematic diagram of an exemplary embodiment of an insulated nozzle assembly 200, such as an insulated threaded nozzle assembly. Insulated nozzle assembly 200 includes a nozzle 210 and an insulating member 280 surrounding nozzle 210. In the illustrated embodiment, insulating member 280 is a concentric tube comprising an inner wall 282 and an outer wall 284 spaced apart from inner wall 282, thereby defining an annular space 286. In some embodiments, insulating member 280 further includes a removable gasket 288. Gasket 288 can be removed to facilitate filling or emptying annular space 286 with insulation. Any insulation suitable for the operating temperatures within the nozzle may be used. For example, a particulate insulation, fibrous- or rope-type insulation, or a foaming/setting liquid insulation may be used. Advantageously, the insulation is a high-efficiency, high-temperature insulation, such as a ceramic or mineral material. One suitable granular insulating material is Microtherm® insulation (Microtherm Inc., Alcoa Tenn.), a silica powder having a particle size of 5-25 nm.

In certain embodiments, nozzle 210 is an embodiment of a threaded nozzle as described herein. Accordingly, nozzle 210 may include a first substantially tubular member 220 and a second substantially tubular member 230. First member 220 and second member 230 are removably coupled via a threaded portion 260. First member 220 is in fluid communication with second member 230 such that a gas 265 (e.g., a fluidization gas) can flow upwardly through first and second members 220, 230. Insulating member 280 may surround first member 220, second member 230, or both as illustrated.

FIG. 9 is a schematic diagram of another exemplary embodiment of an insulated nozzle assembly 300, such as an insulated threaded nozzle assembly. Insulated nozzle assembly 300 includes a nozzle 310, a substantially tubular outer member 370 concentrically surrounding nozzle 310, and an insulating member 380 surrounding outer member 370. In the illustrated embodiment, insulating member 380 is a concentric tube comprising an inner wall 382 and an outer wall 384 spaced apart from inner wall 382, thereby defining an annular space 386. In some embodiments, insulating member 380 further includes a removable gasket 388. Gasket 388 can be removed to facilitate filling or emptying annular space 386 with insulation.

In certain embodiments, nozzle 310 is an embodiment of a threaded nozzle as described herein. Accordingly, nozzle 310 may include a first substantially tubular member 320 and a second substantially tubular member 330. First member 320 and second member 330 are removably coupled via a threaded portion 360. First member 320 is in fluid communication with second member 330 such that a gas 365 (e.g., a fluidization gas) can flow upwardly through first and second members 320, 330.

In some arrangements, outer member 370 comprises an outer wall 372 spaced concentrically apart from an outer wall surface 320a of first member 320, an outer wall surface 330a of second member 330, or both, to form an annular space 374. Outer member 370 further comprises an inlet 376 in fluid communication with annular space 374. A gas 378 (for example, a secondary or fluidizing gas) can flow into annular space 374 through inlet 376, and upwardly through annular space 374.

Embodiments of the disclosed nozzle assemblies enable removal and/or replacement of the second member without removal and/or replacement of the entire nozzle assembly. When the second member is in need of removal and/or replacement, the fluid bed reactor is placed into a resting state, i.e., fluidization and reaction gas flows are reduced or stopped so that fluidization ceases, and the reactor temperature may be reduced. With reference to FIGS. 1 and 2, second member 30 is detached from first member 20 by disengaging the first and second member threads at threaded portion 60. Second member 30 is then removed. In some examples, second member 30 is replaced by a replacement second member. In some arrangements, the replacement second member may have a different length, a different diameter or configuration (e.g., an outward flare or inward taper at its upper end), and/or be constructed of different material(s) than second member 30. In another example, second member 30 may be cleaned by removing silicon deposits and reused. The replacement second member, or cleaned second member, is reinserted into the reactor chamber and coupled to first member 20 by engaging the first and second member threads to re-form threaded portion 60. In some embodiments, before inserting the replacement or cleaned second member, an orifice plate 50 is inserted into first member 20 or a previously placed orifice plate 50 is removed and/or replaced.

### II. Closable Valve Assembly

Upwardly-facing nozzles within a fluid bed reactor, such as a silicon deposition reactor, can become occluded if seed particles fall into the nozzle when charging the reactor. Upwardly-facing nozzles also can become clogged when there is insufficient gas flow through the nozzle during reactor operation, and seed and/or product particles fall into the nozzle. Disclosed herein are embodiments of a closable valve assembly configured to prevent nozzle clogging from particles falling into the nozzle during low and/or no gas flow situations.

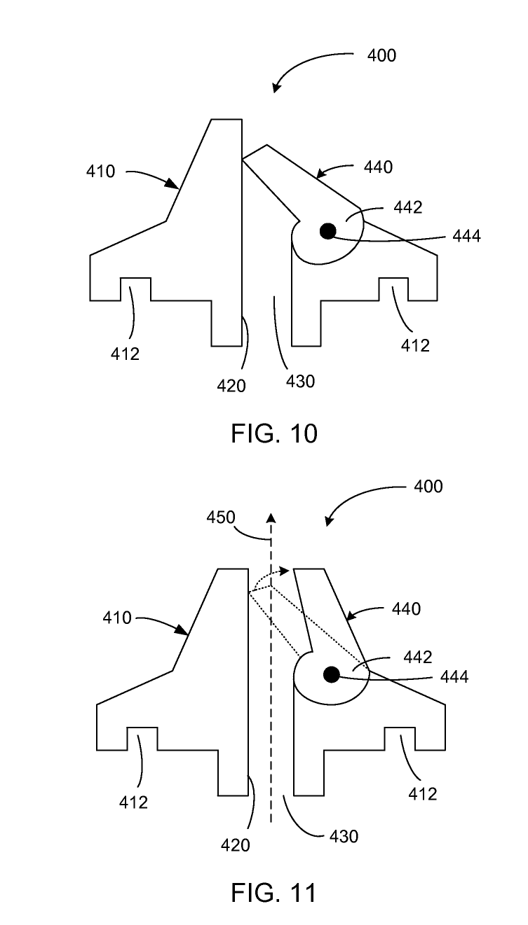

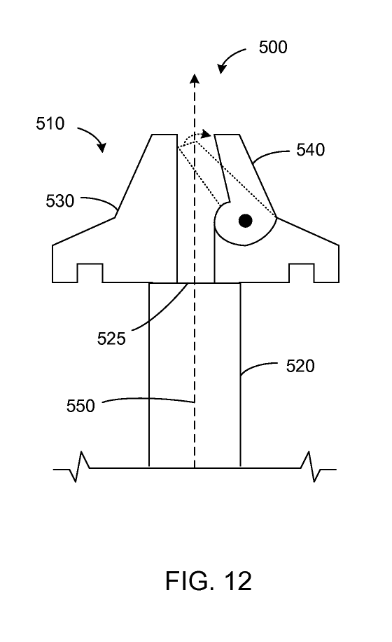

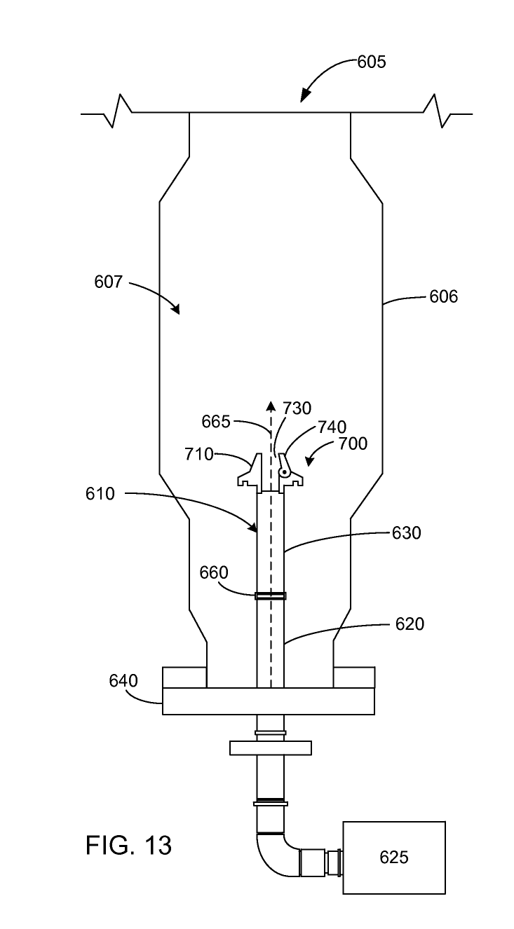

FIGS. 10 and 11 are schematic cross-sectional views of one embodiment of a closable valve assembly 400. Valve assembly 400 comprises a valve body 410. An inner wall surface 420 of valve body 410 defines a central passageway 430. Valve body 410 may include a recessed portion 412. In some example, recessed portion 412 is positioned and dimensioned to accommodate an upper edge of an outer member and/or insulating member as described herein. Valve assembly 400 further includes a movable gate 440. A base portion 442 of gate 440 is pivotally connected to a portion of valve body 410 by pivot connector 444. Gate 440 is movable between a closed first position (FIG. 5) at least partially blocking central passageway 430 and an open second position (FIG. 6). When a gas 450 flows through central passageway 430 with sufficient velocity, gate 440 moves from the closed position to an open position. Then the gas flow rate is sufficiently high to open gate 440, particles do not fall into the central passageway 430. When gas flow ceases or has insufficient velocity and force, gate 440 returns to the closed position (FIG. 5), thereby preventing particles from falling into central passageway 430.

FIG. 10 is a cross-sectional view of closable nozzle assembly 500 comprising a closable valve assembly 510 secured to a nozzle 520. In some embodiments, nozzle 520 is a threaded nozzle as disclosed herein. The nozzle may be insulated. Closable valve assembly 510 comprises a valve body 530 and a gate 540 pivotally connected to valve body 530. As a gas 550 flows upwardly through nozzle 520, gate 540 moves from a first, closed position (dotted line) to a second, open position (solid line). In the closed position, gate 540 at least partially covers orifice 525 of nozzle 520.

Valve assembly 510 can be secured to nozzle 520 by any suitable means including, but not limited to, welding, spot welding, riveting, or threaded means. In some embodiments, valve 510 may be removably secured to nozzle assembly by threaded means. For example, valve assembly 510 may include external threads on an outer wall surface on a lower portion of valve body 530, and nozzle 520 may include internal threads on an inner wall surface adjacent to orifice 525, wherein the threads are cooperatively dimensioned to removably fit together with the threads on valve body 530. Alternatively, valve assembly 510 may include internal threads on an inner cylindrical surface of lower portion of valve body 530, and nozzle 520 may include external threads on an outer wall surface adjacent to orifice 525, wherein the threads are cooperatively dimensioned to removably fit together with the threads on valve body 530.

In some embodiments, a reclosable valve assembly is secured to a threaded nozzle assembly as disclosed herein. Desirably, the valve assembly is secured to the nozzle assembly in a manner that permits removal and/or replacement of the nozzle's second member. In one embodiment, the valve assembly is secured only to the second member. The valve assembly and second member may be removed together as a single unit, such as when the valve assembly is welded, spot welded, or riveted to the second member. Alternatively, the valve assembly may be removably attached to the second member so that the valve assembly can removed in a first step, and the second member can be removed in a subsequent step. In another embodiment, the valve assembly may be detachably secured to a nozzle assembly, e.g., a nozzle assembly that includes an outer member and/or an insulated jacket, so that the valve assembly can be removed in a first step and the second member can be removed in a subsequent step.

Components of the disclosed closable valve assemblies are constructed using any material that is acceptable within the expected pressure, temperature and stress requirements within the fluidized bed reactor. Suitable materials for use in a heated silicon deposition reactor include high-temperature metal alloys such as, but not limited to, INCOLOY® and HASTALLOY™ alloys. Surfaces exposed to seed particles, product particles, and/or reaction gases may be coated, e.g., with silicon carbide, for product quality.

FIG. 11 is a schematic diagram of a fluid bed reactor 605 including an exemplary embodiment of a threaded nozzle assembly 610 with a closable valve assembly 700. An outer wall 606 defines a reaction chamber 607. Nozzle assembly 610 comprises a first member 620 and a second member 630. First member 620 is configured to extend through a bottom wall 640 of fluid bed reactor 605. First member 620 and second member 630 are detachably coupled via a threaded portion 660. Valve assembly 700 is secured to nozzle assembly 610 by any suitable means. Valve assembly 700 comprises a valve body 710 defining a central passageway 730. Valve assembly 700 further includes a movable gate 740. Nozzle assembly 610 is in fluid communication with a gas source 625. A gas 665 can flow upwardly through first and second members 620, 630, and through central passageway 730 of valve assembly 700 into reaction chamber 607. Although not illustrated, nozzle assembly 610 may include an outer member and/or an insulating member as described previously and shown in FIGS. 7-9.

In view of the many possible embodiments to which the principles of the disclosure may be applied, it should be recognized that the illustrated embodiments are only preferred examples and should not be taken as limiting the scope of the disclosure. Rather, the scope of the disclosure is defined by the following claims. We therefore claim as our invention all that comes within the scope and spirit of these claims.

We claim:

1. A nozzle assembly for a fluid bed reactor, comprising:
a first member configured to extend upwardly from a bottom wall of a fluid bed reaction chamber, the first member having an inlet at a first end positioned at or below the bottom wall of the fluid bed reaction chamber and an upwardly facing outlet at a distal end that is positioned above the inlet when the nozzle is installed in a fluid bed reactor, wherein the first member defines a passageway in fluid communication with the inlet and the outlet, the first member further comprising threads adjacent to the outlet; and
a second member having an inlet at a first end and an upwardly facing orifice at a second end, wherein the second member defines a passageway in fluid communication with the inlet and the outlet, and wherein the inlet is in fluid communication with the first member outlet, the second member further comprising threads adjacent to the inlet, wherein threads are positioned and cooperatively dimensioned to engage with the threads on the first member such that the first member and the second member are detachably fitted together.

2. The nozzle assembly of claim 1 wherein the first member is rectilinear, the second member is rectilinear, or both the first member and the second member are rectilinear.

3. The nozzle assembly of claim 1 wherein the first member inlet is in fluid communication with a gas source.

4. The nozzle assembly of claim 1 where the nozzle assembly further comprises an orifice plate positioned within at least one of the passageways to restrict a flow of gas through the passageways, the orifice plate being removable when the first member and the second member are not fitted together.

5. The nozzle assembly of claim 3 wherein the gas source is a source of a silicon-bearing gas.

6. The nozzle assembly of claim 1 wherein the first member threads are on an outer wall surface adjacent to the first member outlet, and the second member threads are on an inner wall surface adjacent to the second member inlet.

7. The nozzle assembly of claim 1 wherein the first member threads are on an inner wall surface adjacent to the first member outlet, and the second member threads are on an outer wall surface adjacent to the second member inlet.

8. The nozzle assembly of claim 1, further comprising an insulating member positioned around the first member, the second member, or both the first member and the second member.

9. The nozzle assembly of claim 1, further comprising a tubular outer member positioned around the first member, the second member, or both, wherein the outer member comprises a wall spaced apart from an outer surface of the first member, the second member, or both the first member and the second member, thereby defining an annular space between the outer member wall and the outer surface.

10. The nozzle assembly of claim 9 wherein the annular space is in fluid communication with a gas source.

11. The nozzle assembly of claim 9, further comprising an insulating member positioned around the outer member.

12. A closable nozzle assembly for a heated silicon deposition reactor system, comprising:
a nozzle configured to extend upwardly into a reaction chamber of a heated silicon deposition reactor system, the nozzle comprising
an inlet in fluid communication with a gas source, and
an upwardly facing orifice in fluid communication with the inlet and positioned to inject a gas upwardly into the reaction chamber; and
a valve assembly connected to the nozzle, the valve comprising
a valve body, and
a gate pivotally connected to the valve body, wherein the gate is movable between a first position wherein the orifice is at least partially covered in the absence of gas flow, and a second position wherein the orifice is not covered when gas flows through the orifice.

13. The closable nozzle of claim 12, further comprising an insulating member positioned around the nozzle.

14. The closable nozzle assembly of claim 12 wherein the nozzle is a threaded nozzle assembly, further comprising:
a first member configured to extend upwardly from a bottom wall of a fluid bed reaction chamber, the first member having an inlet at a first end positioned at or below the bottom wall of the fluid bed reaction chamber and an upwardly facing outlet at a distal end that is positioned above the inlet when the nozzle is installed in a fluid bed reactor, wherein the first member defines a passageway in fluid communication with the inlet and the outlet, the first member further comprising threads adjacent to the outlet; and
a second member having an inlet at a first end and an upwardly facing orifice at a second end, wherein the second member defines a passageway in fluid communication with the inlet and the outlet, and wherein the inlet is in fluid communication with the first member outlet, the second member further comprising threads adjacent to the inlet, wherein threads are positioned and cooperatively dimensioned to engage with the threads on the first member such that the first member and the second member are detachably fitted together.

15. The closable nozzle assembly of claim 14 wherein the valve assembly is connected to the second member.

16. The closable nozzle assembly of claim 14, further comprising an insulating member positioned around the first member, the second member, or both.

17. The closable nozzle assembly of claim 14 wherein the nozzle further comprises a tubular outer member positioned around the first member, the second member, or both, wherein the outer member comprises a wall spaced apart from an outer surface of the first member, the second member, or both the first member and the second member, thereby defining an annular space between the outer member wall and the outer surface, wherein the annular space is in fluid communication with a gas source.

18. The closable nozzle assembly of claim 17, further comprising an insulating member positioned around the outer member.

19. The closable nozzle assembly of claim 12 wherein the valve assembly is removably connected to the nozzle.

20. The closable nozzle assembly of claim 19 wherein the nozzle comprises a threads adjacent to the orifice and the valve assembly comprises threads on a lower portion of the valve body, wherein the valve assembly threads are positioned and cooperatively dimensioned to engage with the nozzle threads such that the valve assembly and the nozzle are detachably fitted together.

21. A fluid bed reactor, comprising:
an outer wall surrounding a reaction chamber;
a nozzle assembly comprising
a first member configured to extend upwardly from a bottom wall of a fluid bed reaction chamber, the first member having an inlet at a first end positioned at or below the bottom wall of the fluid bed reaction chamber and an upwardly facing outlet at a distal end that is positioned above the inlet when the nozzle is installed in a fluid bed reactor, wherein the first member defines a passageway in fluid communication with the inlet and the outlet, the first member further comprising threads adjacent to the outlet, and
a second member having an inlet at a first end and an upwardly facing orifice at a second end, wherein the second member defines a passageway in fluid communication with the inlet and the outlet, and wherein the inlet is in fluid communication with the first member outlet, the second member further comprising threads adjacent to the inlet, wherein threads are positioned and cooperatively dimensioned to engage with the threads on the first member such that the first member and the second member are detachably fitted together; and
a gas source in fluid communication with the first member inlet.

22. The fluid bed reactor of claim 21, further comprising a closable valve assembly comprising:
a valve body; and
a gate pivotally connected to the valve body, wherein the gate is movable between a first position wherein the second member orifice of the nozzle assembly is at least partially covered in the absence of gas flow, and a second position wherein the orifice is not covered when gas flows through the orifice.

23. A method for maintaining a fluid bed reactor, wherein the fluid bed reactor comprises an outer wall surrounding a reaction chamber and a nozzle assembly comprising (a) a first member configured to extend upwardly from a bottom wall of the reaction chamber, the first member having an inlet at a first end positioned at or below the bottom wall of the reaction chamber and an upwardly facing outlet at a distal end that is positioned above the inlet when the nozzle is installed in a fluid bed reactor, wherein the first member defines a passageway in fluid communication with the inlet and the outlet, the first member further comprising threads adjacent to the outlet, and (b) a second member having an inlet at a first end and an upwardly facing orifice at a second end, wherein the second member defines a passageway in fluid communication with the inlet and the outlet, and wherein the inlet is in fluid communication with the first member outlet, the second member further comprising threads adjacent to the inlet, wherein threads are positioned and cooperatively dimensioned to engage with the threads on the first member such that the first member and the second member are capable of being detachably fitted together, the method comprising:
detaching the second member from the first member by disengaging the second member threads from the first member threads while the fluid bed reactor is in a non-fluidized state;
removing the second member from the reaction chamber;
inserting a replacement second member into the reaction chamber, wherein the replacement second member comprises an inlet at a first end an upwardly facing orifice at a second end, wherein the second member defines a passageway in fluid communication with the inlet and the outlet, the replacement second member further comprising threads adjacent to the inlet, wherein the replacement second member threads are positioned and cooperatively dimensioned to engage with the threads on the first member such that the first member and the replacement second member are capable of being detachably fitted together; and
engaging the replacement second member threads with the threads on the first member to provide a nozzle assembly.
